(19) United States
(12) Patent Application Publication
(10) Pub. No.: US 2022/0078273 A1
(43) Pub. Date: Mar. 10, 2022

(54) Stand for Mobile Electronic Device with Privacy Feature

(71) Applicant: Nikola Taisha Naylor-Warren, Arnold, PA (US)

(72) Inventor: Nikola Taisha Naylor-Warren, Arnold, PA (US)

(21) Appl. No.: 17/012,627

(22) Filed: Sep. 4, 2020

(51) Int. Cl. H04M 1/04; G02B 7/182

(52) U.S. Cl. CPC H04M 1/04; G02B 7/182

(57) ABSTRACT

A stand to support a mobile device and a mirror has a base to which panels are attached. The mirror is supported by the stand for viewing the device. The panels are angularly oriented with respect to the base and each has a slot adapted to receive the mobile device and a slot adapted to receive the mirror. The slot adapted to receive the mirror is in spaced relation to the slot adapted to receive the mobile device. The panels may be integrally formed with the base or may be attached by hinges having detents or springs to support the panels in a desired orientation.

### FIELD OF THE INVENTION

This invention relates to stands for supporting electronic devices such as mobile phones and tablets.

### BACKGROUND

It is advantageous to use multiple devices, such as a computer, a mobile phone and/or a tablet simultaneously. While a computer screen and keyboard are ergonomically designed for use at a desk, the same cannot be said for mobile devices, which are designed primarily to be hand held. Mobile devices therefore do not have support features which allow them to be conveniently viewed and used in conjunction with other mobile devices or desk top or laptop computers. In addition, while using the mobile devices, for example, participating in on-line meetings via an active camera mounted on the device screen, instances may arise where privacy is needed while continuing to view the on-line meeting. For privacy the device and the camera may be turned away from the user. There is no feature which facilitates continued viewing the on-line meeting while the device is turned away. There is clearly a need for a support for mobile devices which allows them to be readily viewed and used when not being held in the hand, and also provides a way of viewing the device while the device and camera face away from the user.

### SUMMARY

The invention concerns a stand for supporting an electronic device and a mirror for viewing the device. One example embodiment of a stand according to the invention comprises a base having first and second sides oppositely disposed from one another. A first panel has a first side attached to the first side of the base and a second side oppositely disposed. The first panel is oriented angularly with respect to the base. A first slot is positioned in the first panel. The first slot extends from the second side toward the first side of the first panel. The first slot is adapted to receive and support the electronic device. A third slot is positioned in spaced apart relation from the first slot. The third slot extends from the second side toward the first side of the first panel. The first slot is adapted to receive and support the electronic device.

By way of example, the stand may further comprise a second panel having a first side attached to the second side of the base and a second side oppositely disposed. The second panel is oriented angularly with respect to the base. A second slot is positioned in the second panel. The second slot extends from the second side of the second panel toward the first side of the second panel. The second slot is adapted to receive and support the electronic device. A fourth slot is positioned in the second panel in spaced apart relation to the second slot. The fourth slot extends from the second side of the second panel toward the first side of the second panel. The fourth slot is adapted to receive and support the mirror.

As an example, the first and second panels may be angularly oriented toward one another in an example embodiment. In another example, the first and second panels may be angularly oriented away from one another. By way of example, the first and second panels may be integrally formed with the base. Further by way of example, at least a portion of the base or at least a portion of the first or second panels are covered by a substrate. A further example embodiment the base is adapted to store the mirror between the panels.

In an example, the third slot is oriented at a slot angle relative to a normal to the base and away from the first slot. The fourth slot is oriented at the slot angle away from the second slot. In a particular example, the slot angle ranges from 30 to 60 degrees. In another particular example, the slot angle ranges from 50 to 60 degrees.

Another example stand for supporting an electronic device according to the invention comprises a base having first and second sides oppositely disposed from one another. A first panel has a first side attached to the first side of the base and a second side oppositely disposed. At least a first hinge attaches the first panel to the base in this example embodiment. A first slot is positioned in the first panel. The first slot extends from the second side toward the first side of the first panel. The first slot is adapted to receive and support the electronic device. A third slot is positioned in spaced apart relation from the first slot. The third slot extends from the second side toward the first side of the first panel. The first slot is adapted to receive and support the electronic device.

An example embodiment may further comprise a second panel having a first side attached to the second side of the base and a second side oppositely disposed. At least a second hinge attaches the second panel to the base in this example. A second slot is positioned in the second panel. The second slot extends from the second side of the second panel toward the first side of the second panel. The second slot is adapted to receive and support the electronic device. A fourth slot is positioned in the second panel in spaced apart relation to the second slot. The fourth slot extends from the second side of the second panel toward the first side of the second panel. The fourth slot is adapted to receive and support the mirror.

By way of example, the stand may further comprise a first spring acting between the base and the first panel and a second spring acting between the base and the second panel. The first and second springs respectively bias the first and second panels away from the base in an example embodiment. A further example embodiment comprises at least a first detent acting between the base and the first panel. At least a second detent acts between the base and the second panel. The first and second detents may comprise respective detent hinges in an example embodiment. In another example, the first and second detents may comprise respective ratchet hinges.

In an example embodiment, the first and second sides of the base are oriented parallel to one another and the first and second slots are aligned with one another along a line oriented perpendicular to the first and second sides of the base. By way of example, the base may comprise a plate having a rectangular shape defined by two oppositely disposed long sides and two oppositely disposed short sides. In a specific example, the first and second sides comprise the long sides. In a further example, the first and second panels comprise respective plates, each having a rectangular shape. In a particular example, at least a portion of the base or at least a portion of the first or second panels are covered by a substrate. In an example, the base is adapted to store the mirror between the panels.

By way of example, the third slot is oriented at a slot angle relative to a normal to the base and away from the first slot. The fourth slot is oriented at the slot angle away from the second slot. In a particular example, the slot angle ranges from 30 to 60 degrees. In another particular example, the slot angle ranges from 50 to 60 degrees.

### BRIEF DESCRIPTION OF THE DRAWINGS

FIG. 1 is an isometric view of an example embodiment of a stand according to the invention;

FIG. 1A is an end view of the example stand shown in FIG. 1;

FIG. 2 is an isometric view of another example embodiment of a stand according to the invention;

FIG. 2A is an end view of the example stand shown in FIG. 2;

FIG. 3 is an isometric view of another example embodiment of a stand according to the invention;

FIG. 4 is a bottom view of another example embodiment of a stand according to the invention;

FIG. 5 is an isometric view of another example embodiment of a stand according to the invention; and

FIG. 6 is a side view of the example embodiment shown in FIG. 5.

### DETAILED DESCRIPTION

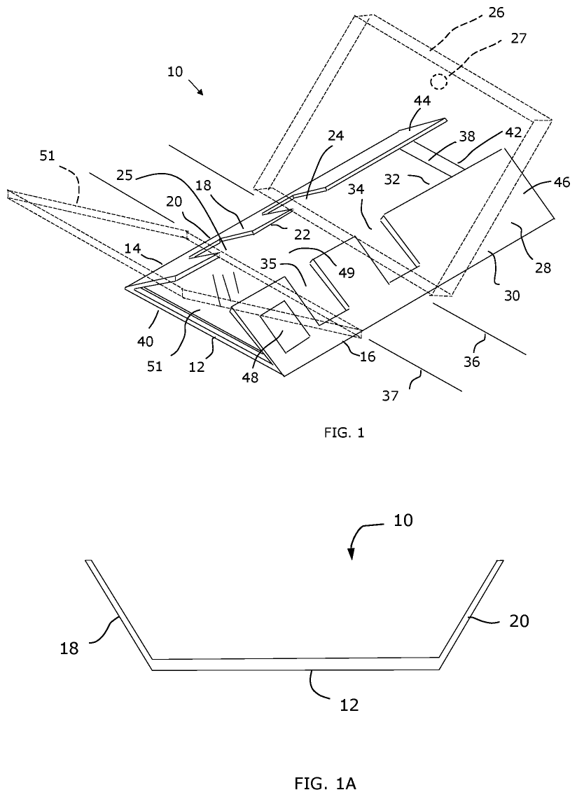

FIG. 1 shows an example embodiment of a stand 10 according to the invention. Stand 10 comprises a base 12 having first and second sides 14 and 16 oppositely disposed from one another. A first panel 18 has a first side 20 which is attached to the first side 14 of base 12. Panel 18 is oriented angularly with respect to the base 12. For a practical design, angles from 30° to 150°, and including 90°, are feasible. Panel 18 also has a second side 22 oppositely disposed from the first side 20. A first slot 24 is positioned in the first panel 18. The first slot 24 extends from the second side 22 of the first panel 18 toward the first side 20. As shown in FIG. 1, the first slot 24 is adapted to receive and support an electronic device 26, such as a mobile phone or a tablet. The mobile device comprises a camera 27. A third slot 25 is positioned in the first panel 18 in spaced apart relation to the first slot 24. The third slot 25 extends from the second side 22 of the first panel 18 toward the first side 20. As shown in FIG. 1, the third slot 25 is adapted to receive and support a mirror 51. The mirror is for viewing the electronic device 26.

Stand 10 may also comprise a second panel 28. Second panel 28 has a first side 30 attached to the second side 16 of the base 12. Second panel 28 is also oriented angularly with respect to base 12 and has a second side 32 oppositely disposed from the first side 30. A second slot 34 is positioned in the second panel 28. The second slot 34 extends from the second side 32 of the second panel 28 toward the first side 30. As further shown in FIG. 1, the second slot 34 is also adapted to receive and support the electronic device 26. A fourth slot 35 positioned in the second panel 28 is spaced apart relation to the second slot 34. The fourth slot 35 extends from the second side 32 of the second panel 28 toward the first side 30. As shown in FIG. 1, the fourth slot 35 is adapted to receive and support the mirror 51.

In the example embodiment shown in FIG. 1 the first and second sides 14 and 16 of base 12 are oriented parallel to one another. The first and second slots 24 and 34 are aligned with one another along a first line 36 oriented perpendicular to the sides 14 and 16. The third and fourth slots 25 and 35 are aligned with one another along a second line 37 oriented perpendicular to the sides 14 and 16. Further by way of example, base 12 comprises a plate 38 having a rectangular shape defined by two oppositely disposed long sides (the first and second sides 14 and 16) and two oppositely disposed short sides 40 and 42. The first and second panels 18 and 28 also comprise respective plates 44 and 46, and each also has a rectangular shape in this example. Panels 18 and 28 are angularly oriented toward one another in this example and are integrally formed with the base 12. In another example shown in FIG. 1A, panels 18 and 28 are angularly oriented away from one another. In a practical example, stand 10 may be formed from a unitary metal plate, for example, aluminum or stainless steel, in which the slots are cut and portions of the plate bent to form the panels. The stand 10 could also be extruded, and made from a plastic resin. All or portions of the base 12 and the panels 18 and 28 may be covered by a substrate 48 such as a decorative decal, ornamental pattern, or a protective plastic resin coating to cite a few examples. The space 49 on the base 12 between the panels 18 and 28 forms a storage area which can be used to hold a writing instrument, the mirror 51, or other items.

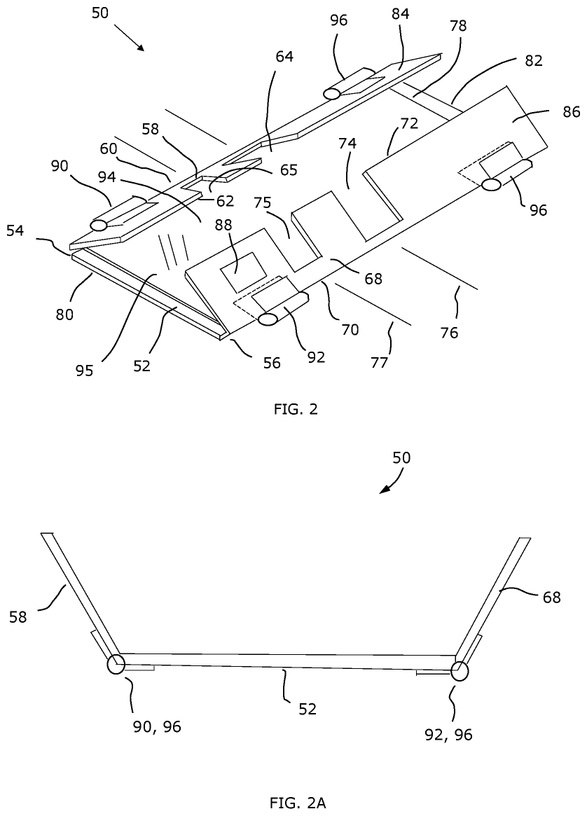

FIG. 2 illustrates another stand embodiment 50 according to the invention. Stand 50 comprises a base 52 having first and second sides 54 and 56 oppositely disposed from one another. A first panel 58 has a first side 60 which is attached to the first side 54 of base 52. In this example, panel 58 is attached to the base 52 via one or more hinges 90. Panel 58 also has a second side 62 oppositely disposed from the first side 60. A first slot 64 is positioned in the first panel 58. The first slot 64 extends from the second side 62 of the first panel 58 toward the first side 60. Like the slot 24, the slot 64 is adapted to receive and support an electronic device, such as a mobile phone or a tablet (see FIG. 1). A third slot 65 is also positioned in the first panel 58 in spaced apart relation to the first slot 64. The third slot 65 extends from the second side 62 of the first panel 58 toward the first side 60. Like the slot 25, the slot 65 is adapted to receive and support a mirror 95.

Stand 50 may also comprise a second panel 68. Second panel 68 has a first side 70 attached to the second side 56 of the base 52. Second panel 68 is also attached to base 52 via one or more hinges 92 and has a second side 72 oppositely disposed from the first side 70. A second slot 74 is positioned in the second panel 68. The second slot 74 extends from the second side 72 of the second panel 68 toward the first side 70. The second slot 74 is also adapted to receive and support an electronic device. A fourth slot 75 is also positioned on the second panel 68 is spaced apart relation to the second slot 74. The fourth slot 75 extends from the second side 72 of the second panel 68 toward the first side 70. The fourth slot 75 is also adapted to receive and support the mirror 95.

In the example embodiment shown in FIG. 2 the first and second sides 54 and 56 of base 52 are oriented parallel to one another. The first and second slots 64 and 74 are aligned with one another along a first line 76 oriented perpendicular to the sides 54 and 56. The third and fourth slots 65 and 75 are aligned with one another along a second line 77 oriented perpendicular to the sides 54 and 56. Further by way of example, base 52 comprises a plate 78 having a rectangular shape defined by two oppositely disposed long sides (the first and second sides 54 and 56) and two oppositely disposed short sides 80 and 82. The first and second panels 58 and 68 also comprise respective plates 84 and 86, and each also has a rectangular shape in this example. All or portions of the base 52 and the panels 58 and 68 may be covered by a substrate 88 such as a decorative decal, ornamental pattern, or a protective plastic resin coating to cite a few examples. The space 94 on the base 52 between the panels 58 and 68 forms a storage area which can be used to hold a writing instrument, a mirror 95, or other items.

The use of hinges 90 and 92 to attach panels 58 and 68 to the base 52 allows the angle between the panels and the base to be varied to best suit the particular device being supported by the stand 50. For a practical design, angles from 30° to 150°, and including 90°, are feasible. FIGS. 2 and 2A illustrate both acute (FIG. 2) and obtuse (FIG. 2A) orientations of the panels 58 and 68. Acute orientation angles have the panels angled toward one another; obtuse orientation angles have the panels angled away from one another. To this end, it is advantageous that one or more of the hinges comprise a detent 96 acting between base 52 and the panels 58 and 68. Example detent hinges are found in U.S. Pat. No. 2,097,651 which discloses a ratchet-type detent, and U.S. Pat. No. 4,501,045, which discloses a spring biased plunger type detent. U.S. Pat. Nos. 2,097,651 and 4,501,045 are hereby incorporated by reference. The detent 96, in the form of hinges 92 and 94, permit the angle between the panels 58 and 68 and the base 52 to be set as desired, and still allow the panels to be folded flat against the base for convenient storage of the stand 50. Hinges which use friction to hold the angular position between panels are also feasible.

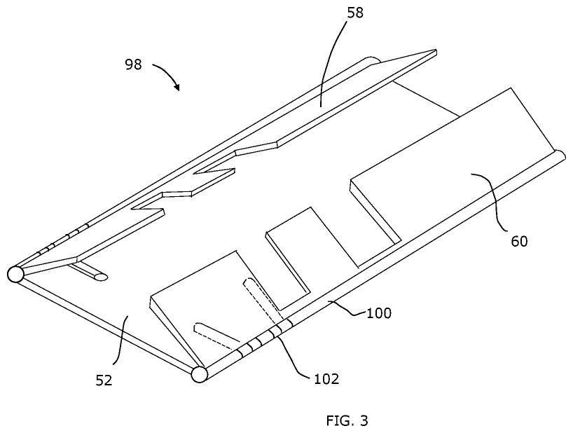

FIG. 3 shows another example embodiment of a stand 98 which uses single hinges 100, such as piano hinges, to attach panels 58 and 68 to base 52. Springs 102 acting between the base and each of the panels may be used to support the panels at a desired angle with respect to the base 52.

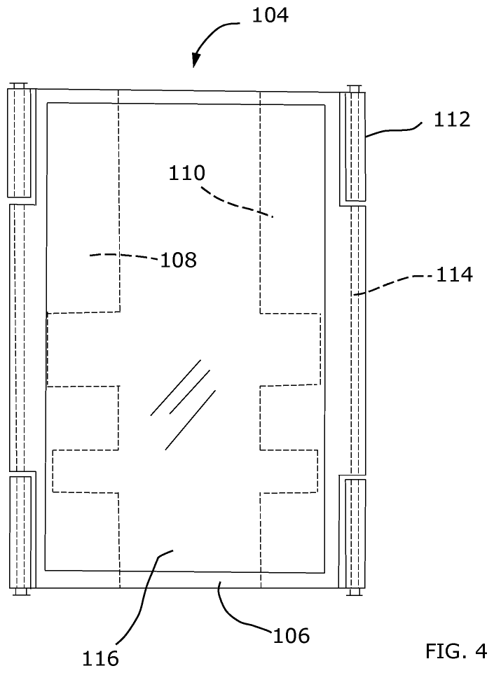

FIG. 4 shows a bottom view of another example embodiment of a stand 104. Stand 104 comprises a base 106 to which side panels 108 and 110 are attached by hinges 112. Hinges 112 on each side of the base 106 conform to the outline of the stand and pivot on a single shaft 114. The hinges may be detent hinges, for example ratchet type, or ball type, or plunger detents as noted above, as well as frictional hinges to permit side panels 108, 110 to rotate to a desired angular position relative to the base 106, and then remain in that position until moved again. Stand embodiment 104 may also have a mirror 116 stored on the base 106, in this example the mirror being on the bottom surface of the base, opposite to panels 108 and 110.

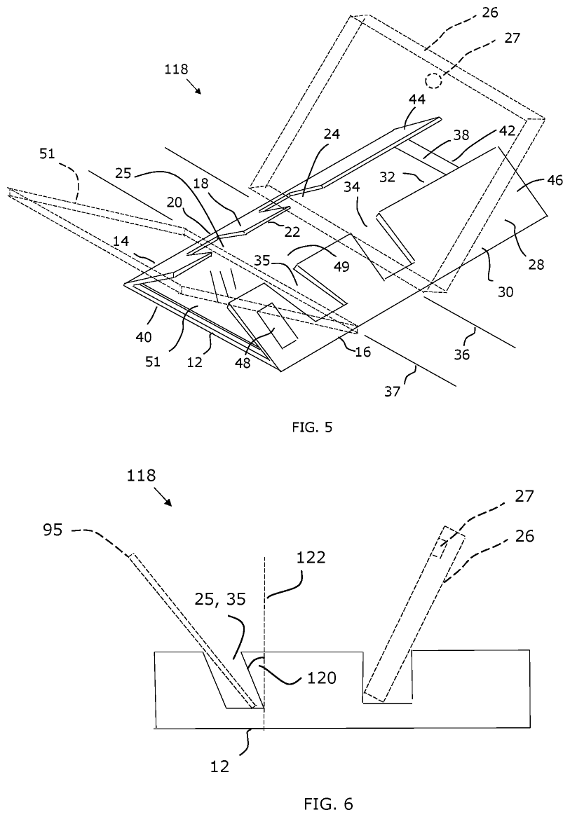

FIG. 5 shows an example embodiment of a stand 118 according to the invention. Stand 118 is similar to stand 10 (FIG. 1). However, the third and fourth slots 25 and 35 of stand 118 are oriented at a slot angle 120 relative to a normal 122 to the base 12 and away from the first and second slots 24 and 34, as shown in FIG. 6. The slot angle 120 may range from 30° to 60°. The slot angle 120 may also range from 50° to 60°.

In use the first and second slots 24 and 34 of stand 10 receive mobile device 26, as shown in FIG. 1. The device 26 supported by stand 10 is advantageously able to be operated and viewed independent of support by the user, during an on-line meeting for example. To advantageously provide privacy while still using the device 26, the device may be turned away from the user and the mirror 51 may be unmounted from the base plate 12, and received by the third and fourth slots 25 and 35. The mirror 51 may be used to view the device 26 while camera 27 faces away from the user.

Stands as disclosed herein are expected to provide greater convenience for the use of mobile devices such as mobile phones and tablets.

What is claimed is:

1. A stand for supporting an electronic device and a mirror for viewing said electronic device, said stand comprising:
a base having first and second sides oppositely disposed from one another;
a first panel having a first side attached to said first side of said base and a second side oppositely disposed, said first panel being oriented angularly with respect to said base;
a first slot positioned in said first panel, said first slot extending from said second side toward said first side of said first panel, said first slot being adapted to receive and support said electronic device;
a third slot positioned in spaced apart relation to said first slot, said third slot extending from said second side toward said first side of said first panel, said third slot being adapted to receive and support said mirror.

2. The stand according to claim 1, further comprising:
a second panel having a first side attached to said second side of said base and a second side oppositely disposed, said second panel being oriented angularly with respect to said base;
a second slot positioned in said second panel, said second slot extending from said second side of said second panel toward said first side of said second panel, said second slot being adapted to receive and support said electronic device;
a fourth slot positioned in said second panel in spaced apart relation to said second slot, said fourth slot extending from said second side of said second panel toward said first side of said second panel, said fourth slot being adapted to receive and support said mirror.

3. The stand according to claim 2, wherein said first and second panels are angularly oriented toward one another.

4. The stand according to claim 2, wherein said first and second panels are angularly oriented away from one another.

5. The stand according to claim 2, wherein said first and second panels are integrally formed with said base.

6. The stand according to claim 2, wherein at least a portion of said base or at least a portion of said first or second panels are covered by a substrate.

7. The stand according to claim 1, wherein said base is adapted to store said mirror between said panels.

8. A stand for supporting an electronic device and a mirror for viewing said electronic device, said stand comprising:
a base having first and second sides oppositely disposed from one another;
a first panel having a first side attached to said first side of said base and a second side oppositely disposed;
at least a first hinge attaching said first panel to said base;
a first slot positioned in said first panel, said first slot extending from said second side toward said first side of said first panel, said first slot being adapted to receive and support said electronic device;
a third slot positioned in spaced apart relation from said first slot, said third slot extending from said second side toward said first side of said first panel, said third slot being adapted to receive and support said mirror.

9. The stand according to claim 8, further comprising:
a second panel having a first side attached to said second side of said base and a second side oppositely disposed;
at least a second hinge attaching said second panel to said base;
a second slot positioned in said second panel, said second slot extending from said second side of said second panel toward said first side of said second panel, said second slot being adapted to receive and support said electronic device;
a fourth slot positioned in said second panel in spaced apart relation from said second slot, said fourth slot extending from said second side of said second panel toward said first side of said second panel, said fourth slot being adapted to receive and support said mirror.

10. The stand according to claim 9, further comprising a first spring acting between said base and said first panel and a second spring acting between said base and said second panel.

11. The stand according to claim 10, wherein said first and second springs respectively bias said first and second panels away from said base.

12. The stand according to claim 9, further comprising:
at least a first detent acting between said base and said first panel;
at least a second detent acting between said base and said second panel.

13. The stand according to claim 12, wherein said first and second detents comprise respective detent hinges.

14. The stand according to claim 12, wherein said first and second detents comprise respective ratchet hinges.

15. The stand according to claim 9, wherein said first and second sides of said base are oriented parallel to one another, said first and second slots are aligned with one another along a first line oriented perpendicular to said first and second sides of said base, and said third and fourth slots are aligned with one another along a second line oriented perpendicular to said first and second sides of said base.

16. The stand according to claim 9, wherein said base comprises a plate having a rectangular shape defined by two oppositely disposed long sides and two oppositely disposed short sides.

17. The stand according to claim 16, wherein said first and second sides comprise said long sides.

18. The stand according to claim 17, wherein said first and second panels comprise respective plates, each having a rectangular shape.

19. The stand according to claim 9, wherein at least a portion of said base or at least a portion of said first or second panels are covered by a substrate.

20. The stand according to claim 8, wherein said base is adapted to store said mirror between said panels.

21. The stand according to claim 2, wherein said third slot is oriented at a slot angle relative to a normal to said base and away from said first slot, and said fourth slot is oriented at said slot angle away from said second slot.

22. The stand according to claim 21, wherein said slot angle ranges from 30 to 60 degrees.

23. The stand according to claim 21, wherein said slot angle ranges from 50 to 60 degrees.

24. The stand according to claim 9, wherein said third slot is oriented at a slot angle relative to a normal to said base and away from said first slot, and said fourth slot is oriented at said slot angle away from said second slot.

25. The stand according to claim 24, wherein said slot angle ranges from 30 to 60 degrees.

26. The stand according to claim 24, wherein said slot angle ranges from 50 to 60 degrees.
